(19) United States
(12) Patent Application Publication
(10) Pub. No.: US 2003/0086437 A1
(43) Pub. Date: May 8, 2003

(54) Overcoming neighborhood capture in wireless LANs

(76) Inventor: Mathilde Benveniste, South Orange, NJ (US)

Correspondence Address: Mathilde Benveniste, 76 Harding Drive, South Orange, NJ, 07079, US

(21) Appl. No.: 10/290,020

(22) Filed: Nov. 7, 2002

Related U.S. Application Data
(60) Provisional application No. 60/331,030, filed on Nov. 7, 2001.
(60) Provisional application No. 60/342,343, filed on Dec. 21, 2001.

(51) Int. Cl. H04L 12/43

(52) U.S. Cl. 370/461

(57) ABSTRACT

A method is disclosed for addressing the problem of neighborhood capture, which arises in a multiple-cell wireless LAN with fewer channels available than the number of cells. Channel selection in WLAN networks must be accompanied by dynamic bandwidth allocation in order to avoid interference between co-channel cells. CSMA-type MAC protocols provide dynamic bandwidth allocation in a distributed manner, obviating the need for a central controller. With such protocols, time-overlapped transmissions by stations in non-interfering co-channel cells cooperate to capture the channel for long time periods. The result is deleterious to QoS because of the ensuing access delays in other co-channel cells.

According to this invention, the neighborhood capture problem is mitigated through Global Channel Release. The method provides for all stations to release the channel at pre-specified times, ideally regularly-spaced. All co-channel cells are thus given an equal opportunity to contend for the channel. The method eliminates unfairness due to the synergy of the cells in a reuse group in capturing the channel, at the expense of co-channel cells outside that group. The method also provides for the synchronization of stations in all cells. Synchronization occurs constantly, starting as stations power up. Safeguards are provided for the elimination of inequities by distributing traffic loads equally across both cells and reuse groups for all stations to have the same success rate in seizing the channel.

Benefit is hereby claimed to the following co-pending applications:

1) U.S. Provisional Application Serial No. 60/331,030, filed Nov. 7, 2001, entitled “‘Neighbourhood’ Capture in CSMA/CA WLANs,” by Mathilde Benveniste, and

2) U.S. Provisional Application Serial No. 60/342,343, filed Dec. 21, 2001, entitled “Wireless LANS and ‘Neighborhood Capture’,” by Mathilde Benveniste.

### BACKGROUND OF THE INVENTION

1. Field of the Invention

This invention relates to wireless communications and more particularly relates to coordinating RF use in multiple cells of a wireless system sharing the same RF spectrum.

2. Related Art

Wireless LANs are wireless networks that provide inexpensive, high-speed, wireless communications in office buildings, the home, public areas, and a variety of commercial and industrial spaces. A station in a wireless LAN (WLAN) can be a personal computer, a bar code scanner, or other mobile or stationary device with the appropriate integrated chip set or a wireless network interface card to make the connection over a wireless link to other stations. WLANs generally operate at peak speeds ranging between 1 and 54 Mbps, and have a range between 15 and 100 meters.

Wireless LANs provide wireless peer-to-peer communication between stations and access to the wired network. A single-cell WLAN may serve a group of stations communicating directly via the wireless medium; this is called an ad hoc network. It can typically support several users and still keep access delays at an acceptable level. Single-cell WLANs are suitable for small single-floor offices, stores, and the home network where data is exchanged directly. and still keep access delays at an acceptable level. Single-cell WLANs are suitable for small single-floor offices, stores, and the home network where data is exchanged directly.

Multiple-cell WLANs provide greater range than single-cell WLANs by using access points (APs) to interconnect several single-cell WLANs. The AP can be thought of as the counterpart of the base station of a mobile cellular communications system. Communication among stations, or between a station and the wired network, may be established with the aid of a wired backbone network, known as the distribution system. An AP is a station that serves as a gateway to the distribution system; it is analogous to the base station of a cellular communications network. Such a WLAN is known as an infrastructure network, to distinguish it from single-cell WLANs that are not connected to a backbone network, which are known as independent networks. Multiple-cell wireless LANs can cover larger multiple-floor buildings. A mobile appliance (e.g., laptop computer, SmartPhone, or data collector) can roam within the coverage areas of cells while maintaining a live connection to the backbone network.

Of the multitude of wireless LAN specifications and standards, IEEE 802.11 technology has emerged as a dominant force for the enterprise WLAN market over the past years. IEEE 802.11b is the newest 802.11 standard—finalized in September 1999. IEEE 802.11b high-rate products started shipping in late 1999. IEEE 802.11a, the 5 GHz extension to 802.11b, will provide higher speeds at a range less than half of 802.11b. [The IEEE 802.11 Wireless LAN Standard is published in three parts as IEEE 802.11-1999; IEEE 802.11a-1999; and IEEE 802.11b-1999, which are available from the IEEE, Inc. web site http://grouper.ieee.org/groups/802/11.] Other wireless LAN standards include: Open Air (which was the first wireless LAN standard), HomeRF (designed specifically for the home networking market), and HiperLAN/2 (the European counterpart to the “American” 802./11a standard). [For more information about HomeRF, see HomeRF Working Group's learning center at web site http://www.homerf org/leaming_center/. An overview of the HIPERLAN Type 1 principles of operation is provided in the publication HIPERLAN Type 1 Standard, ETSI ETS 300 652, WA2 December 1997. An overview of the HIPERLAN Type 2 principles of operation is provided in the Broadband Radio Access Networks (BRAN), HIPERLAN Type 2; System Overview, ETSI TR 101 683 VI.I.1 (2000-02) and a more detailed specification of its network architecture is described in HIPERLAN Type 2, Data Link Control (DLC) Layer; Part 4. Extension for Home Environment, ETSI TS 101 761-4 V1.2.1 (2000-12).] Bluetooth is often listed as a WLAN standard, but it is not. It is aimed at the market of low-power, short-range, wireless connections used for remote control, cordless voice telephone communications, and close-proximity synchronization communications for wireless PDAs/hand-held PCs and mobile phones. The Bluetooth Special Interest Group, Specification Of The Bluetooth System, Version 1.1, Feb. 22, 2001, describes the principles of Bluetooth device operation and communication protocols.

Wireless LANs operate in the unlicensed portions of the spectrum, where they provide interference-free simultaneous transmissions on multiple channels; each cell transmits on a single channel. The number of channels available varies with the spectrum allocation and physical layer technology. For instance, the IEEE 802.11b standard provides 3 TDD channels for duplex data transmission at speeds up to 11 Mbps in the 2.4 GHz ISM band, while IEEE 802.11a provides 8 channels at speeds up to 54 Mbps in the 5 GHz band.

For multiple-cell WLANs, the limited availability of channels implies that they must be reused, much like in cellular communication networks. But unlike in cellular networks, the number of channels available in wireless LANs is not adequate to ensure both contiguous coverage (which is essential for roaming) and interference-free connections at the same time. As a result, cells assigned the same channel may experience co-channel interference in the area of overlapping coverage or near a cell's periphery. The problem of overlapping cell coverage is acute when WLANs are installed without any awareness of what other WLANs are operating nearby. Consequently, multiple-cell WLANs must rely on a medium access control (MAC) protocol to allocate channel time among stations in order to avoid co-channel interference between cells, just as it avoids contention among stations within the same cell.

MAC Protocols for WLANs

Channel access mechanisms for asynchronous data transfer commonly fall into two categories: distributed contention based and centralized contention free. Under contention-based access methods, stations access the channel when there is data to transmit, thus risking collision with transmissions attempted by other stations. Contention-free access methods permit a single station to transmit at a time. With centralized contention-free protocols, a controller—typically the AP—polls stations to send or receive data.

Special MAC protocols were needed for wireless LANs for the following reasons: transmission is flawed by higher bit error rates, different losses are experienced on a wireless channel depending on the path on which the signal travels, and a radio node cannot listen while transmitting. Additive noise, path loss and multipath result in more retransmissions and necessitate acknowledgements, as successful transmission cannot be taken for granted. The different losses experienced along different paths cause different nodes to receive transmissions at different strengths, giving rise to the phenomenon of ‘hidden terminals’. [See E. A. Tobagi and L. Kleinrock. Packet switching in radio channels: Part II-the hidden terminal problem in carrier sense multipleaccess and the busy tone solution. IEEE Transactions on Communications, COM-23(12):14171433, 1975.] These are terminals that cannot hear or be heard by the source, but are capable of causing interference to the destination of a transmission. The message exchange mechanism known as Request-to-Send/Clear-to-Send (RTS/CTS) alleviates this problem. [See P. Karn. MACA—a new channel access method for packet radio. In AARUCRRL Amateur Radio 9th Computer Networking Conference, pages 13440, 1990.] RTS/CTS provides also a reservation mechanism that can save bandwidth in wireless LANs. The inability to detect a collision as quickly as it can be detected on cable with CSMA/CD (carrier-sense multiple access with collision detection) causes more channel time to be wasted in a collision while waiting for the entire frame to transmit before the collision is detected. Hence, carrier sensing is combined with backoff when a new frame arrives to give CSMA/CA (carrier-sense multiple access with collision avoidance).

Receiving signals at different strengths, depending on their origin, gives rise to capture effects. A known capture effect, the “near-far capture”, results from stronger signals being received successfully, while other stations transmit at the same time. It leads to inequities, as throughput is greater for nearby stations while distant stations are starved. In infrastructure WLANs, where all communications occur through the AP, the inequity can be remedied by applying power control at the station (i.e., on the uplink). By equalizing the signal strength received at the AP, all transmissions have equal probability of success.

We present here another form of capture, which we call “neighborhood capture”, that arises when a channel is used by multiple cells. This capture effect occurs because there are too few channels available in the allotted spectrum to provide adequate reuse separation between co-channel cells, even with planned placement of the cells—not to mention an ad hoc placement. In this document we describe the neighborhood capture phenomenon and propose a method to prevent its occurrence.

The remainder of this section gives some background on the existing IEEE 802.11 standard MAC protocols and on enhancements presently under consideration for adoption into this standard. The problem of overlapping cell coverage for co-channel cells is also discussed

IEEE 802.11 MAC Protocols

The MAC origins of the 802.11 standard lie in the IEEE 802.3 wired LAN standard. The cell in the IEEE 802.11 architecture is known as the basic service area (BSA), and the group of stations that can communicate either directly with one another or with the same AP form the basic service set (BSS). Two channel access mechanisms are standardized for the IEEE 802.11 MAC sublayer, which must co-exist: the distributed coordination function (DCF) and the point coordination function (PCF). The DCF is required and is the sole access mechanism in ad hoc networks. The PCF is an optional access mechanism, designed to facilitate periodic time-bounded traffic. [See IEEE 802.11-1999.]

The DCF relies on the Ethernet MAC protocol, CSMA, which has been adapted to provide the basic access mechanism for 802.11 WLANs. The rules for channel access require that a station with pending transmissions use carrier sensing, in order to determine whether the channel is idle. If so, transmission is deferred by a randomly selected delay following completion of the current transmission; this avoids collision with transmissions from other stations waiting for the release of the channel. This deferral time is used to set the backoff timer, which is decreased only when the channel remains idle following a transmission for a period equal to the Distributed Inter-Frame Space (DIFS). Transmission is attempted when this timer expires. The DCF employs the RTS/CTS message exchange as a means of dealing with hidden terminals and to reserve the channel for longer transmissions.

Under the PCF, the channel is reserved for a time interval, the contention-free period (CFP), during which the AP transmits its data and polls other stations in the cell, one at a time, to receive and transmit data. The AP sends a beacon to initiate the CFP and a special frame to designate its completion. The beacon contains the repetition time of a CFP, which is observed by stations in the BSS; the stations refrain from transmitting when a new CFP is due to start. Since DCF and PCF must co-exist on the same channel, an AP accesses the channel by contention; it seizes the channel before any stations contending through DCF by waiting after completion of a transmission for a shorter idle period than is required of DCF stations. To access the channel following a transmission, a DCF station must wait for an idle time interval equal to DIFS, which is longer than the PCF Inter-Frame Space (PIFS), the waiting time for the AP.

All channel reservations, generated either with an RTS/CTS exchange or for a CFP, are made with the aid of the Network Allocation Vector (NAV), a timer maintained by all stations; the NAV is set at the value of the duration field broadcast when the reservation is announced, either by the RCTS or CTS frames, or with the PCF beacon. All stations in a cell defer access until the NAV expires. The NAV thus provides a virtual carrier sense mechanism.

The IEEE 802.11e Draft Standard

A special IEEE 802.11 study group is presently considering enhancements to the MAC protocols that achieve acceptable quality of service (QoS). Proposals for both a QoS enhanced DCF (EDCF) and a QoS enhanced PCF (EPCF) are under review.

The proposed EDCF employs the Tiered Contention Multiple Access (TCMA) protocol. [See M. Benveniste. TCMA, A QoS-Based Distributed MAC Protocol. PIMC'2002, Lisbon, Sept 2002.] The basic access rules of TCMA are similar to CSMA with the following differences: transmission deferral and backoff countdown depend on the priority classification of the data. A station still waits for an idle time interval before attempting transmission following a busy period, but the length of this interval is no longer equal to DIFS; instead it is equal to the Arbitration-Time Inter-Frame Space (AIFS), which varies with the priority of the data. A shorter AIFS is associated with higher priority data. As a consequence, higher priority data gets to the channel faster. In addition, countdown of the backoff timer does not commence when a busy period completes unless the channel has been idle for a period equal to AIFS. This causes backoff countdown of lower priority frames to slow down, and even freeze if there are higher priority frames ready to transmit, a common occurrence in congestion.

The proposed EPCF maintains multiple traffic queues at the stations for different traffic categories; higher priority frames are scheduled for transmission first. Delays are reduced through improved polling-list management. Only active stations are kept on the polling list; a station with data to transmit must reserve a spot on that list, where it stays as long as it is active and for a limited number of inactive polling cycles. A reservation is needed to place a station on the polling list.

The hybrid coordinationfunction (HCF) has been proposed to provide a generalization of PCF. It allows for contention-free transfers and polling to occur as needed; not necessarily at predetermined regular repeat times, as provided by the PCF. The AP can thus send (and possibly receive) data to stations in its BSS on a contention-free basis. This contention-free session, referred to as a controlled access period (CAP), helps an AP transmit its traffic, which is typically heavier in infrastructure cells (since stations must communicate exclusively through the AP). As in the case of the PCF, the HCF permits access to the channel by the AP after waiting for an idle period of length equal to PIFS. [See M. Fischer. Introduction to the TGe Hybrid Coordination Function (HCF). IEEE P802.11 Wireless LANs, Submission IEEE 802.11-01/308, May 2001. IEEE 802.11 submissions can be obtained from the IEEE, Inc. web site http://grouper.ieee.org/groups/802/11.]

Attention is also given by the study group to the problem of co-channel overlapping BSSs (OBSSs). Channel reuse in multiple-cell WLANs poses a problem for the PCF and HCF, as contention-free sessions (CFSs) are generated without coordination among co-channel APs to help prevent time overlap; this measure is needed in situations where cells are within interference range of each other. The existing standard does not provide adequate coordination for contention-free sessions in such situations. The DCF does not require special measures, as stations operating under the DCF deal with interference from stations in other cells in exactly the same manner as they deal with interference from stations in their own cell.

OBSSs and Dynamic Bandwidth Allocation

All stations within the cell operate on one duplex TDD channel, with only one station in each cell transmitting data at any given time. In order to preserve power, stations go into a sleeping mode, which prevents frequent changes of the operating channel. Channel assignments should thus be fixed or static; static assignments permit slow adaptation to traffic pattern changes over the course of a day. Ideally, these assignments must be made optimal through the use of fixed or adaptive non-regular channel assignment methods [See Benveniste, U.S. Pat. No. 5,404,574, “Apparatus and Method for Non-Regular Channel Assignment in Wireless Communication Networks”], which are based on measurement-derived reuse criteria [See M. Benveniste. Selfconfigurable Wireless Systems: Spectrum Monitoring in a Layered Configuration, Globecom '99, Rio de Janeiro, Brazil, December, 1999]. With such an approach, statistical interference relationships between cells are established from measurements of the signal strength between stations and APs in different cells; optimization methods use these relationships to assign the available channels to cells. Ad hoc channel assignment methods, like Dynamic Frequency Selection of Hiperlan2 can be used, but with less promising results, as the reuse distances between co-channel cells are not selected optimally. [See B. C. Jones and D. J. Skellern. HIPERLAN System Performance Under DCA and FCA. Waves of the Year 2000+PIMC '97. The 8th IEEE International Symposium on Personal, Indoor and Mobile Radio Communications. Technical Program, Proceedings Part vol. 3 p. 1216-20, Helsinki Finland, Sep. 1-4 1997.]

The limited number of channels available in the unlicensed band (3 channels for IEEE 802.11b), will lead to a high degree of overlap in the coverage areas of co-channel cells. This is exacerbated by the ad hoc placement of WLANs that results in overlapping BSAs. The channel time (or bandwidth) must thus be allocated among multiple co-channel cells in order to avoid interference. To be efficient, the channel should not remain idle if there is data waiting for transmission; so, while channel selection must be fixed or static, bandwidth allocation should be dynamic (possibly changing on a per-transmission basis). Without a central controller allocating bandwidth among cells, a distributed mechanism is needed for dynamic bandwidth allocation.

A distributed dynamic bandwidth allocation mechanism is simply a distributed contention-based MAC protocol. It must enable sharing of the channel among APs and DCF stations in co-channel cells, as HCF and DCF co-exist. With APs accessing the channel to initiate contention-free sessions (CFPs or CFBs) before DCF stations, a prioritized distributed MAC protocol is needed; such a protocol would also handle different priority DCF data.

The priority-based distributed MAC protocol for EDCF, TCMA, can be used to allocate the channel time among co-channel cells in a multiple-cell WLAN. The APs would be treated as a class with priority above the highest DCF priority class; they would be assigned therefore a shorter AIFS than the highest-priority EDCF data. Other variations of CSMA are also appropriate. In general, a carrier-sense-based MAC protocol would help avoid interference between cells as it causes conflicting transmissions—either DCF transmissions or CFSs—to occur at statistically (or deterministically, depending on the protocol) different times in co-channel cells.

The objective of dynamic bandwidth allocation is to promote fair access to the channel for all co-channel cells. That is, the success rate of a cell in accessing its assigned channel either by its AP generating CFSs or by (E)DCF transmissions, should be independent of its location, assuming comparable traffic loads. Without fair access, transmissions can be delayed excessively in the disadvantaged cell, thus failing to meet QoS requirements. This goal is not realized with a traditional CSMA-type of protocol however when channel reuse is allowed because of a capture effect, which is described in this section. We call this capture effect neighborhood capture.

### SUMMARY OF THE INVENTION

A method and system are disclosed to remedy ‘neighborhood capture’, a new capture effect that arises when Ethernet-type protocols are employed in multiple-cell wireless local area networks (WLANs) that re-use RF channels. Given the small number of channels available, co-channel cells cannot all transmit simultaneously without causing interference on one another. A carrier-sense contention-based MAC protocol can allocate channel bandwidth among co-channel cells dynamically and in a distributed manner, but if used without precautions, it may lead to channel capture; mutually non-interfering co-channel neighbors could deprive other co-channel neighbors of access. In general, there will be instability, with the channel retained by a group of cells for long time intervals. This would cause delays, with negative impact on QoS.

### DESCRIPTION OF THE FIGURES

FIG. 1 shows three co-channel cells A, B, and C comprising nine stations, some within sufficient proximity to cause co-channel interference.

FIG. 2 shows separately, for each of the three cells of FIG. 1, the periods the channel is busy as a result of transmissions generated in each cell when the cells do not function in accordance with the invention.

FIG. 3 shows four cells split into two reuse groups: one comprising cells A and C, and another comprising cells B and D.

FIG. 4 shows how capture will be mitigated in the three co-channel cell scenario of FIG. 1 when the cells function in accordance with the invention.

FIG. 5 illustrates how equal size busy intervals are foreshortened in order to meet the requirements of the invention.

FIG. 6 illustrates busy periods of maximum length shorter than the super-frame duration, transmitted in accordance with the invention.

FIG. 7 illustrates an exemplary synchronization process.

### DESCRIPTION OF THE PREFERRED EMBODIMENT

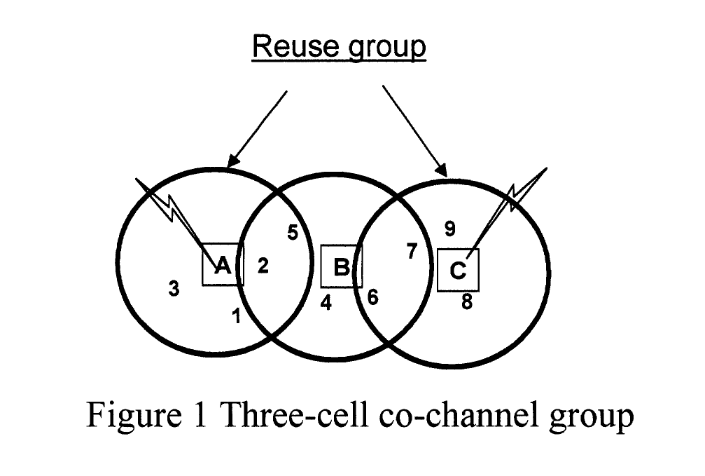

The invention is directed to the elimination of the neighborhood capture phenomenon. Neighborhood capture can be understood by considering a multiple-cell WLAN where three cells have been assigned the same channel; we refer to these cells as a co-channel group. As illustrated in FIG. 1, the three cells A, B, and C comprise nine stations; stations 1, 2, and 3 make up cell A with station 3 serving as the AP, stations 4, 5, and 6 make up cell B with station 4 as its AP, and stations 7, 8, and 9 make up cell C with station 9 as the AP. Cells A and C are not within interference range of each other; they are called a reuse group. Stations in the pair of cells A-B, or B-C, are however within possible interference range of one another.

All stations use a CSMA-type of protocol to access the channel, which involves some form of carrier sensing (either actual or virtual). A station will refrain from transmitting while the channel is busy, and transmission will be deferred until the backoff timer expires. Backoff countdown occurs while the channel is sensed idle and an idle time interval equal to the AIFS for the priority of the pending transmission has elapsed following a busy period.

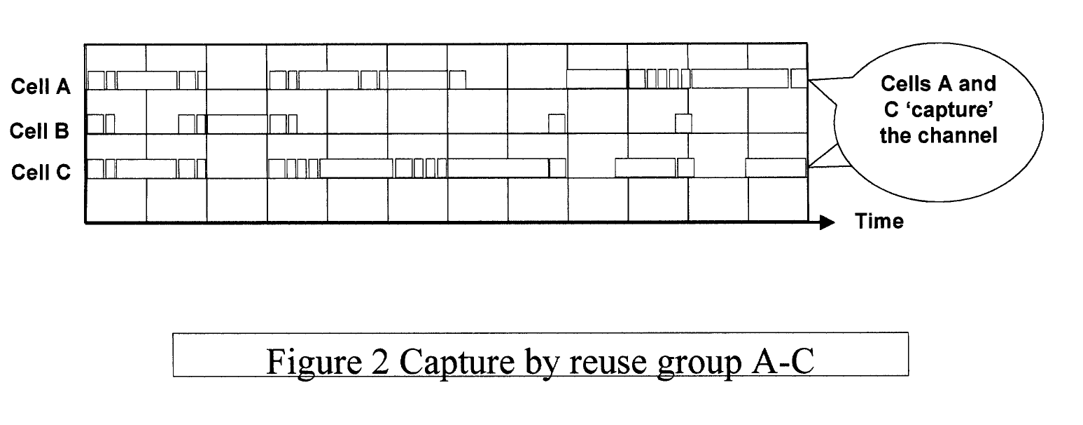

Because different cells hear different transmissions, depending on their location relative to other co-channel cells, their backoff countdown rates are different; as a consequence, cell B will have difficulty accessing the channel. In FIG. 2 we show the periods the channel is busy as a result of transmissions generated in each cell. Busy periods are separated by the Short InterFrame Spaces (SIFS) and idle time slots needed for AIFS and backoff delay. (AIFS equals a SIFS plus a variable number of time slots.) A station in cell A may transmit at the same time as stations in cell C. Stations in cell A must refrain from transmitting only when stations in cell B are transmitting. Stations in cell B are pre-empted from accessing the channel by transmissions in either of its interfering neighbors, cells A or C.

Because transmissions have variable lengths, it is very likely under loaded traffic conditions for a station in cell A to start a transmission before a transmission in cell C expires, and vice versa. As a result, cells A and C will capture the channel, not allowing a chance for stations in cell B to transmit. In general, one would expect that periphery cells, or cells at the top or bottom floors of a multiple-story building equipped with a multiple-cell WLAN, to be likely to capture the channel, at the expense of cells in the same co-channel group located in the interior. In this example, a cell is disadvantaged not only because its competition for the channel—namely, the reuse group comprising cells A and C—has a greater combined offered load, but also because selected station members of a reuse group may transmit simultaneously, thus prolonging their retention of the channel.

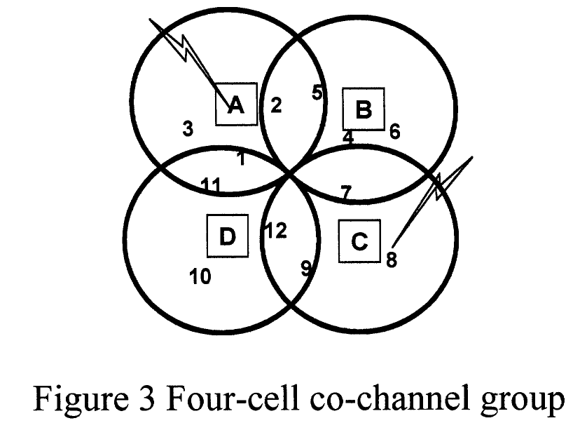

Even when all cells have the same degree of competition from neighbors in the same co-channel group, there is still a problem. Consider the situation in FIG. 3 illustrating four cells; each cell has two competing co-channel neighbors. Two reuse groups exist in this co-channel group of cells: one comprising cells A and C, and another comprising cells B and D. As before, under loaded traffic conditions, a station in cell A may start a transmission before completion of a transmission in cell C, thus failing to release the channel for access by cells B and D. The same is true for stations in cells B and D; if a station in either cell seizes the channel, it will not be released unless there is no pending traffic in the other cell. Assuming the offered loads in the two groups of non-interfering cells are the same, they have equal probability of capturing the channel; hence, there is no a priori unfairness in this case. Once the channel is accessed by one reuse group, however, it will be captured and deprive access to the other group. In general, instability in channel access would result, with long channel retention periods by each reuse group.

The capture effect will be worst if traffic loads are balanced across cells, as the synergy of cells in the same reuse group is maximum in that case. Equal traffic loading across cells is desirable for fair access in a multiple-cell WLAN, as the probability of accessing the channel successfully within a cell decreases with increasing load. In order to avoid unfairness, one would want to size cells (through AP power adjustment) so that the traffic loads in all cells are equal. Load balancing magnifies the negative impact of neighborhood capture, however, as the channel will be released only if there is no pending traffic in another cell of the same reuse group. A reuse group thus achieves the maximum retention probability if its combined load is equally split among its members.

Neighborhood capture has a negative impact on QoS delivery. Transmissions in cells outside the reuse group capturing the channel will be delayed excessively as they will find the channel busy for long time intervals. In consequence, CFPs could not be initiated as scheduled and periodic and time-critical data will be delayed. The prioritization apparatus put in place for EDCF will also be rendered ineffective.

A remedy for Neighborhood Capture

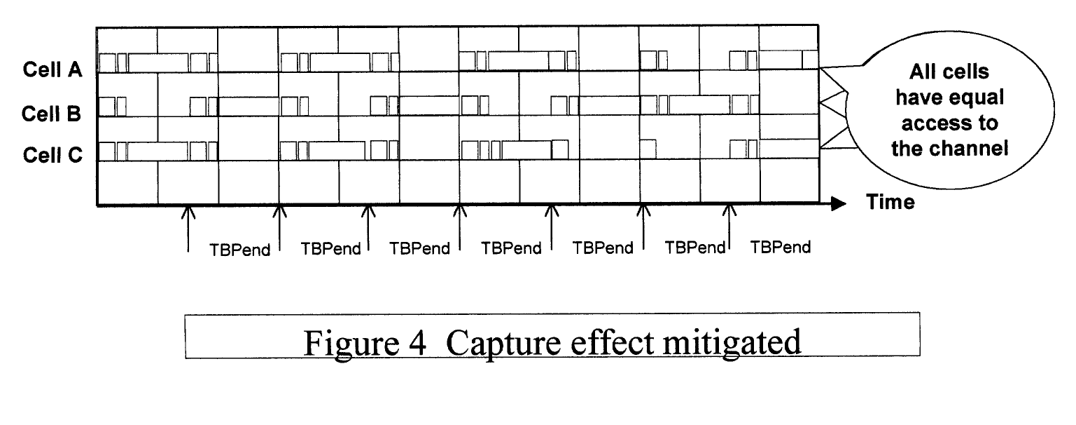

Neighborhood capture can be eliminated by requiring that all BPs to have the same length after adjustments. More generally, if all stations are required to release the channel at pre-specified times, the capture effect would not arise; all competing co-channel cells would have an equal chance to seize the channel. We call this requirement Global Channel Release (GCR). It should occur at regularly-spaced time intervals that are sufficiently close to meet delay and jitter restrictions for time-critical applications such as voice or video. This implies slotting of the channel into super-frames and synchronization of all stations; the resulting protocol would be a Slotted CSMA/CA. FIG. 4 shows how capture will be mitigated in the three co-channel cell scenario of FIG. 1 as a result of the global channel release requirement.

Channel Slotting

The MAC protocol allocates channel time among the following: control and data frames, and contention-free sessions (CFSs), which may be either CFPs or CFBs. CFSs may include all frame exchange sequences generated without contention following a successful channel contention-based access attempt, where contention is avoided through the use of SIFS spacing. A CFS may involve one or more stations and may be initiated by any station. For simplicity, we use the generic term busy period (BP) to designate any of the above; i.e., either single frames or frame sequences that are transmitted on a single contention success.

Different MAC protocols may be used to access the channel for the different BP types; all of them, however, are distributed and based on carrier sensing. BPs are all assigned an AIFS; EDCF stations are assigned AIFS values according to their priority classification; CFPs and CFBs are assigned the shortest possible AIFS value.

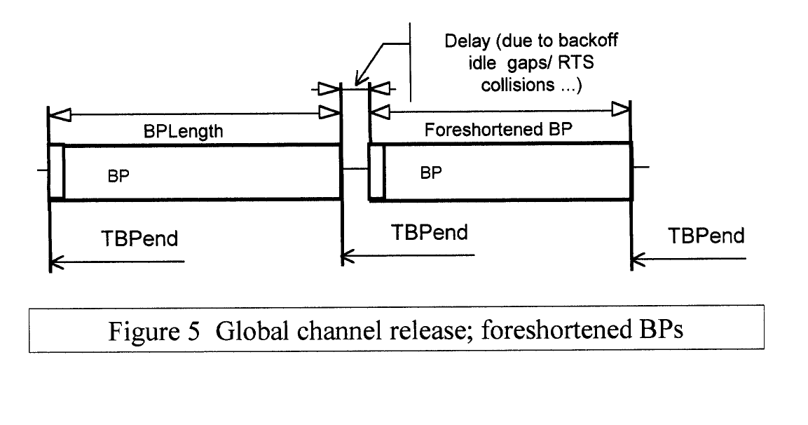

Capture is mitigated by requiring that the channel be free of all activity at pre-specified times, TBPend. The channel time is slotted at equal time intervals, thus creating super-frames of duration SFDuration. BPs may complete before the next frame boundary. As a consequence, the BPs that follow must be foreshortened in order to ensure termination of the BP at the designated slotted time; this length adjustment will account also for idle time spent for AIFS and backoff delay. FIG. 5 illustrates how equal size BPs of length BPLength are foreshortened in order to meet the global channel release requirement. Stations that attempt access unsuccessfully using a short reservation packet (RTS/CTS) may be able to use the channel within the same super-frame. After first engaging in backoff, they may transmit concurrently with successful transmissions provided that they do not interfere. Their BPs may have to be foreshortened in order to release the channel at the next TBPend.

GCR does not eliminate all inequities. By forcing stations to end their BPs at the same time, equal access is offered to all stations in all cells, as there is no synergy of member cells of the same reuse group in retaining the channel. If traffic loads are equally distributed across cells and reuse groups, all stations have a fair chance at the channel. But if the combined offered load is greater in one reuse group, as is possible for instance with group A-C which has more stations, the success rate of cell B would be less. GCR improves the success rate of cell B however relative to what would have been otherwise. To achieve greater fairness, traffic loads in all reuse groups must be comparable; hence the need to balance loads not only across cells, but also across reuse groups.

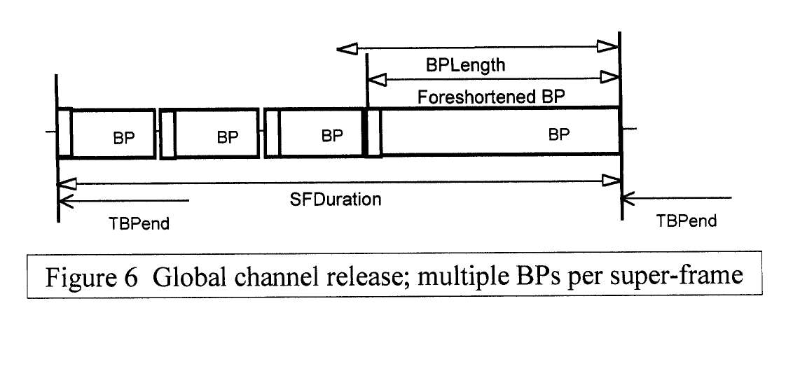

It is not necessary for GCR to occur after each data frame or CFS; it may happen less often. FIG. 6 illustrates BPs of maximum length BPLength shorter than the super-frame duration; in general there may be multiple BPs per super-frame.

Synchronization

In order to avoid their BPs straddling the super-frame boundary, all stations in the multiple-cell WLAN must be synchronized. Synchronization may be achieved in several ways. For instance, within a cell, stations may synchronize with the AP, as is done in the current IEEE 802.11 standard. [See IEEE 802.11-1999.]

However, time offsets may arise between different cells as distant cells [cells that cannot hear each other] power on and synchronize locally, independently of one another. This would happen early in the morning when a few stations are on. As more stations power on and synchronize with their neighbors in the course of the day, asynchrony may arise. Clock adjustment is necessary in order to eliminate time offsets. Station mobility will also introduce new stations into the neighborhood.

Time offsets between cells may be corrected in a way similar to node synchronization in an IBSS (independent BSS). The stations in an IBSS transmit a special frame, like the IEEE 802.11 beacon or probe response frame, carrying a timestamp field. Each station updates its clock if the received time stamp is later. When a station powers on, the initial setting of the clock is 0.

The IEEE 802.11 timing synchronization function (TSF) keeps the timers of all stations within a cell synchronized. The AP initializes its TSF timer independently of other APs and periodically transmits time-stamped frames, in order to synchronize the other stations in the BSS. The stations update their timers after making the proper adjustments for propagation and processing delays.

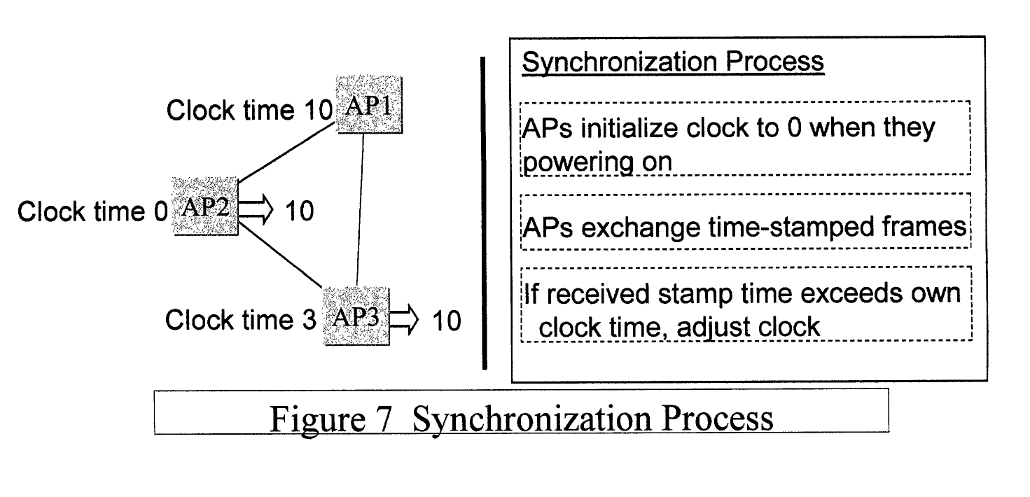

Neighboring co-channel cells would be synchronized via special frames sent by stations in the overlapping coverage area of two cells. An AP receiving such a frame would update its own timer if the received adjusted time-stamp were later, as illustrated in FIG. 7.

Synchronization of timers by this distributed method is maintained within 4 μs plus the maximum propagation delay of the PHY for PHYs of 1 Mbps, or greater within an IBSS. Multiple hops in the synchronization path of a multi-cell system could compound the error, thus leading to a greater timer offset. In order to accommodate mobility, synchronization of timers must occur with sufficient frequency to maintain synchrony of all neighboring co-channel stations at all times.

Other mechanisms, both distributed and centralized, that could achieve smaller timer offsets are also possible for synchronization. In addition to the above-mentioned signaling scheme, synchronization between cells may be pursued through independent control channels, similar to those available in HiperLAN. Signaling may utilize either the wireless medium or the wired distribution system of infrastructure WLAN systems.

Illustrative examples of the invention have been described in detail. In addition, however, many modifications and changes can be made to these examples without departing from the nature and spirit of the invention.

What is claimed is:

1. A method for a distributed medium access protocol that schedules transmission of frames from a plurality of nodes in a wireless access network, on a channel in a way that reduces capture, comprising the steps of:
said nodes transmitting only when the channel is idle according to any medium access protocol based on carrier sensing; and
requiring all nodes engaged in transmission to release the channel at the same time, causing the channel to become idle at that time and thus preventing capture of the channel.

2. The method for a distributed medium access protocol of claim 1, which further comprises:
synchronizing the clocks of the nodes; and
specifying the times when the channel must be released by all transmitting nodes in advance thus preventing channel capture.

3. The method for a distributed medium access protocol of claim 2, which further comprises:
Achieving synchronization of the clocks of all nodes within the same cell by the AP transmitting a frame containing a timestamp to which all associated nodes set their clocks.

4. The method for a distributed medium access protocol of claim 3, which further comprises:
achieving synchronization of the clocks of neighboring cells by initializing the clock of an AP to 0 when powering on;
by the stations in the overlapping coverage area of two cells sending special frames with their timestamps; and
updating the clock of an AP if the received delay-adjusted time-stamp is later than its own.

5. The method for a distributed medium access protocol of claim 3, which further comprises:
Achieving synchronization of the clocks of neighboring APs by signaling on special wireless channels.

6. The method for a distributed medium access protocol of claim 3, which further comprises:
Achieving synchronization of the clocks of all APs by signaling through the wired distribution system of an infrastructure wireless access network.

7. The method for a distributed medium access protocol of claim 1, which further comprises:
distributing to the APs a global channel release schedule by a controller in real time.

8. A method for a distributed medium access protocol that schedules transmission of frames from a plurality of nodes in a wireless access network, on a channel in a way that that reduces capture, comprising the steps of:
balancing traffic loads across cells; and
balancing traffic loads across reuse groups.
